(19) United States
(12) Patent Application Publication
(10) Pub. No.: US 2015/0186257 A1
(43) Pub. Date: Jul. 2, 2015

(54) MANAGING A TRANSFER BUFFER FOR A NON-VOLATILE MEMORY

(71) Applicants: Anand S. Ramalingam, Beaverton, OR (US); Knut S. Grimsrud, Forest Grove, OR (US); Jawad B. Khan, Cornelius, OR (US)

(72) Inventors: Anand S. Ramalingam, Beaverton, OR (US); Knut S. Grimsrud, Forest Grove, OR (US); Jawad B. Khan, Cornelius, OR (US)

(21) Appl. No.: 14/140,919

(22) Filed: Dec. 26, 2013

(51) Int. Cl. G06F 12/02

(52) U.S. Cl. CPC G06F 12/0246

(57) ABSTRACT

Embodiments include apparatuses, method, and systems for managing a transfer buffer associated with a non-volatile memory. In one embodiment, controller logic may be coupled to a non-volatile memory and a transfer buffer. The controller logic may read a plurality of sectors of data from the non-volatile memory and store the read sectors in the transfer buffer. The controller logic may further allocate individual sectors to pages according to a completion time of the read of individual sectors of the plurality of sectors, the individual pages including a plurality of the sectors. The controller logic may further write the pages of sectors to the non-volatile memory responsive to a determination that all sectors of the page have been read.

### FIELD

Embodiments of the present invention relate generally to the technical field of memory. Specific embodiments relate to a managing a transfer buffer associated with a non-volatile memory.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Many solid state drives (SSDs) employ non-volatile memory, such as NAND flash memory, in which a block of memory resources must be erased prior to writing new data to the block. Accordingly, garbage collection must be performed periodically to defragment the non-volatile memory and free up blocks of memory resources for storage of new data. During garbage collection, data stored in a block of memory resources of the non-volatile memory that is still valid data are grouped into pages, which are read from the memory, stored in a transfer buffer, and then re-written to the memory. The block of memory resources is then erased. However, the read operations for some data of the pages may be delayed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example memory system including a memory controller and a non-volatile memory, in accordance with various embodiments.

FIG. 2 illustrates an example method for performing garbage collection on a non-volatile memory in accordance with various embodiments.

FIG. 3 illustrates an example system configured to employ the apparatuses and methods described herein, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, laptop computer, a set-top box, a gaming console, and so forth.

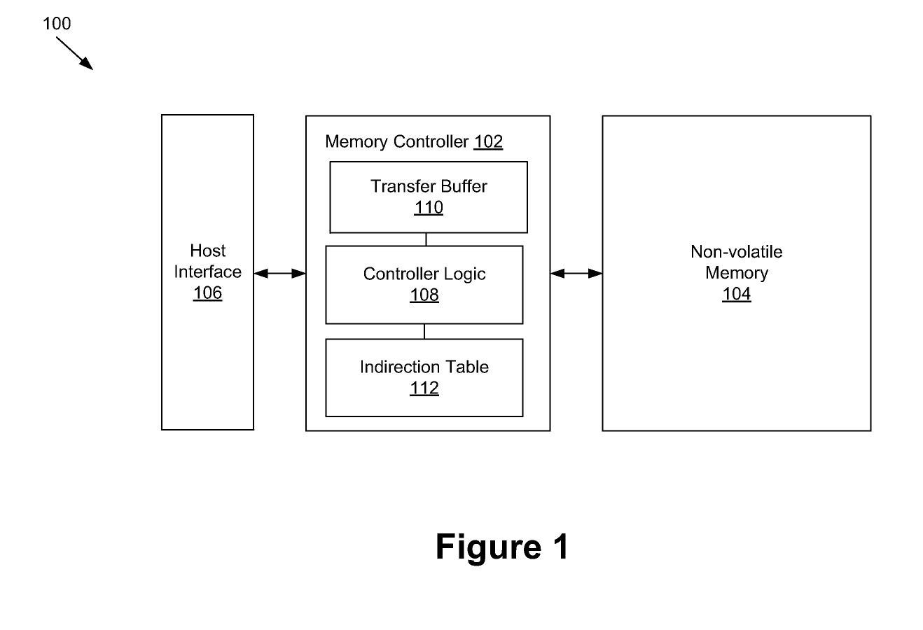

FIG. 1 illustrates a memory system 100 in accordance with various embodiments. In some embodiments, the memory system 100 may implement a solid state drive (SSD). The memory system 100 may include a memory controller 102, a non-volatile memory 104, and a host interface 106.

The non-volatile memory 104 may implement any suitable form of non-volatile memory. For example, in some embodiments, the non-volatile memory 104 may include NAND flash memory. In other embodiments, the memory device 104 may include another type of memory, such as a phase change memory (PCM), a three-dimensional cross point memory array, a resistive memory, nanowire memory, ferro-electric transistor random access memory (FeTRAM), magnetoresistive random access memory (MRAM) that incorporates memristor technology, spin transfer torque (STT)-MRAM, etc. In some embodiments, the non-volatile memory 104 may include a plurality of memory dice.

The memory controller 102 may control writing data into the non-volatile memory 104 and/or reading data from the non-volatile memory 104. The host interface 106 may interface with a host device (e.g., a processor, not shown) to allow the host device to write data into the non-volatile memory 104 and/or read data from the non-volatile memory 104 via the memory controller 102. The host interface 106 may communicate with the host device using one or more communication interface protocols, such as a Serial Advanced Technology Attachment (SATA), Peripheral Component Interconnect express (PCIe), Serial Attached SCSI (SAS), and/or Universal Serial Bus (USB) interface.

In some embodiments, the memory controller 102, non-volatile memory 104, and host interface 106 may be included in a same package. For example, the memory controller 102, memory device 104, and host interface 106 may be disposed on a same printed circuit board.

In various embodiments, the memory controller 102 may include controller logic 108, transfer buffer 110, and an indirection table 112, coupled to one another at least as shown. The indirection table 112 may indicate a location of data in the non-volatile memory 104. The indirection table 112 may include a plurality of data pointers, with each pointer including an identifier of the data and a location in the non-volatile memory 104 where the identified data is stored.

In various embodiments, data stored in the non-volatile memory 104 may be organized into pages, with each page including a plurality of sectors of data. A page may correspond to a granularity of data that the controller logic 104 is able to write to the non-volatile memory 104, and a sector may correspond to a granularity of data used by the indirection table 112 to indicate a location of data in the non-volatile memory 104. The sectors and/or pages may be of any suitable size. In one non-limiting embodiment, a page may include four sectors. For example, a page may be 16 Kilobytes (KiBs) and a sector may be 4 KiB.

In various embodiments, the transfer buffer 110 may include any suitable type of memory, such as static random access memory (SRAM). The transfer buffer may store sectors of data in respective slots of the transfer buffer 110 as part of a garbage collection process, as further discussed below.

In various embodiments, memory resources of the non-volatile memory 104 must be erased prior to writing new data to the memory resources. However, the memory resources of the non-volatile memory 104 may only be erased in a block of memory resources of the non-volatile memory 104 that includes a plurality of pages.

Accordingly, the non-volatile memory 104 may include invalid data (e.g., data to which the indirection table 112 no longer includes a valid data pointer). The data may become invalid, for example, if updated data is written to the non-volatile memory, and/or if the data was temporary data generated by a process of the host device that is no longer running In some embodiments, the indirection table 112 may indicate the locations of invalid sectors in the non-volatile memory 104 in addition to valid sectors. The indirection table 112 may additionally or alternatively include a free list that indicates blocks of the non-volatile memory that do not include data (and are thus available for storage of new data).

In various embodiments, the controller logic 108 may perform a garbage collection process to erase invalid data and free up memory resources of the non-volatile memory 104. As part of the garbage collection process, the controller logic 108 may identify sectors of data, of a block of data that includes a plurality of sectors stored in the non-volatile memory 104, that are valid sectors to be kept. For example, the valid sectors may include data to which a valid data pointer of the indirection table 112 refers. In some embodiments, the controller logic 108 may select a block for garbage collection based on a number of valid sectors stored in the block. For example, the controller logic 108 may select the block with the fewest number of valid sectors stored therein.

In various embodiments, the controller logic 108 may read the valid sectors of data from the non-volatile memory and store the sectors in the transfer buffer 110. The controller logic 108 may allocate individual sectors to pages according to a completion time of the read of individual sectors of the plurality of sectors. For example, the sectors may be allocated to pages sequentially according to their respective completion times. That is, in an embodiment in which a page includes four sectors, the sectors for which reads finish first, second, third, and fourth among the plurality of sectors may be assigned to a first page, the sectors for which reads finish fifth, sixth, seventh, and eight may be assigned to a second page, etc.

In various embodiments, the controller logic 108 may write the individual pages of sectors to the non-volatile memory 104. For example, the controller logic 108 may write the individual pages to the non-volatile memory responsive to a determination that all sectors of the page have been read and/or stored in the transfer buffer 110. The controller logic 108 may update the indirection table 112 to indicate the location of the sectors written to the non-volatile memory. Additionally, the controller logic 108 may erase the pages from the transfer buffer 110 after writing the pages to the non-volatile memory 104, thereby freeing more space in the transfer buffer 110.

Accordingly, assigning individual sectors to pages according to the completion time of the read of the individual sectors may reduce a residency time of the sectors in the transfer buffer 108 (e.g., an amount of time the sector is stored in the transfer buffer 108 before being re-written to the non-volatile memory 104) compared with assigning the sectors to pages prior to reading the sectors from the non-volatile memory. The shorter residency time may, in turn, allow for a smaller transfer buffer 110 to be used for a given size of the non-volatile memory 104.

In various embodiments, the controller logic 108 may erase the data from the block of the non-volatile memory 104 after writing the plurality of pages of valid sectors to the non-volatile memory 104, thereby freeing the memory resources of the block for storing new data.

In some embodiments, the sectors of individual pages that are to be written to the non-volatile memory 104 may be stored in contiguous slots in the transfer buffer 110. For example, the slots of the transfer buffer 110 may have an associated index that corresponds to a physical location of the slot in the transfer buffer 110. A group of slots of the transfer buffer 110 may be allocated for the garbage collection process. The controller logic 108 may assign individual sectors to respective slots of the transfer buffer 110 upon completion of the read of the sector. For example, the sector may be assigned to the available slot of the allocated group of slots with the lowest index. Thus, the pages of slots may be formed from sectors stored in contiguous slots of the transfer buffer 110 (e.g., slots with sequential indexes).

In other embodiments, the sectors of the individual pages that are to be written to the non-volatile memory 104 may be stored in non-contiguous slots of the transfer buffer 110. For example, the controller logic 108 may assign individual sectors of data to respective slots of the transfer buffer 110 upon initiating the read process of the sector. The controller logic 108 may then assign the individual sectors to a page according to a completion time of the read process on the individual sectors, and write the page to the non-volatile memory 104.

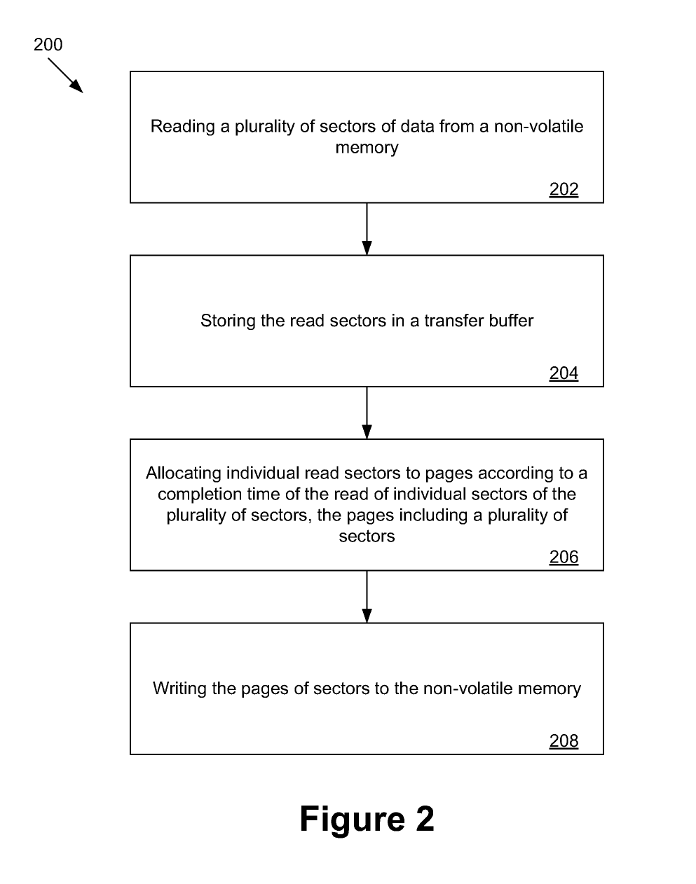

FIG. 2 illustrates a method 200 for garbage collection of a non-volatile memory (e.g., non-volatile memory 104) in accordance with various embodiments. In some embodiments, the method 200 may be performed by a memory controller (e.g., memory controller 102) coupled to the non-volatile memory.

At block 202, the method 200 may include reading a plurality of sectors of data from the non-volatile memory. The sectors may be, for example, valid sectors that are to be kept from a block of data stored in the non-volatile memory that includes a plurality of sectors.

At block 204, the method 200 may further include storing the read sectors in a transfer buffer (e.g., transfer buffer 210).

At block 206, the method 200 may further include allocating individual read sectors to pages according to a completion time of the read of individual sectors of the plurality of sectors. The pages may include a plurality of the sectors.

At block 208, the method 200 may further include writing the pages of sectors to the non-volatile memory. The individual pages may be written to the non-volatile memory responsive to a determination that all sectors of the page have been read and/or stored in the transfer buffer. The pages of sectors may be written to a different location (e.g., a different block) of the non-volatile memory than a location from which the sectors were read at block 202. An indirection table may be updated to indicate a location in the non-volatile memory where the pages of sectors are written at block 208.

In various embodiments, the block of the non-volatile memory from which the sectors were read may be erased after writing all the valid sectors (e.g., in associated pages) from the block to the non-volatile memory. The erased block may then be used for storing new data.

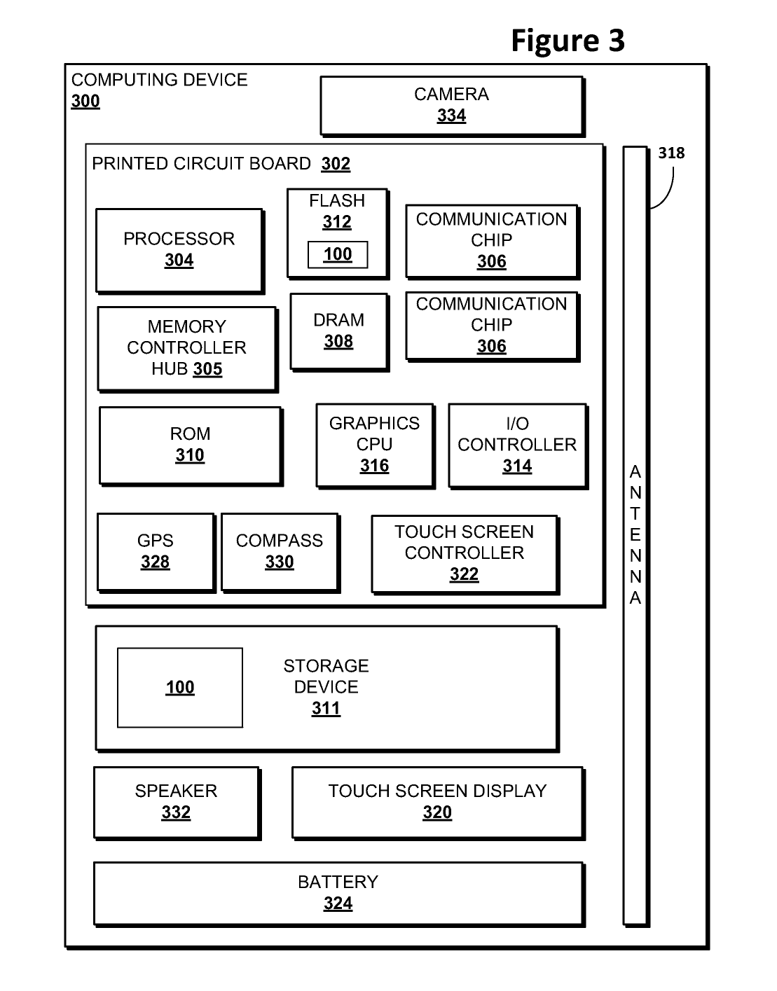

FIG. 3 illustrates an example computing device 300 which may employ the apparatuses and/or methods described herein (e.g., memory system 100, method 200), in accordance with various embodiments. As shown, computing device 300 may include a number of components, such as one or more processor(s) 304 (one shown) and at least one communication chip 306. In various embodiments, the one or more processor(s) 304 each may include one or more processor cores. In various embodiments, the at least one communication chip 306 may be physically and electrically coupled to the one or more processor(s) 304. In further implementations, the communication chip 306 may be part of the one or more processor(s) 304. In various embodiments, computing device 300 may include printed circuit board (PCB) 302. For these embodiments, the one or more processor(s) 304 and communication chip 306 may be disposed thereon. In alternate embodiments, the various components may be coupled without the employment of PCB 302.

Depending on its applications, computing device 300 may include other components that may or may not be physically and electrically coupled to the PCB 302. These other components include, but are not limited to, memory controller hub 305, volatile memory (e.g., DRAM 308), non-volatile memory such as read only memory 310 (ROM), flash memory 312, and storage device 311 (e.g., an SSD or a hard-disk drive (HDD)), an I/O controller 314, a digital signal processor (not shown), a crypto processor (not shown), a graphics processor 316, one or more antenna 318, a display (not shown), a touch screen display 320, a touch screen controller 322, a battery 324, an audio codec (not shown), a video codec (not shown), a global positioning system (GPS) device 328, a compass 330, an accelerometer (not shown), a gyroscope (not shown), a speaker 332, a camera 334, and a mass storage device (such as hard disk drive, a solid state drive, compact disk (CD), digital versatile disk (DVD))(not shown), and so forth. In various embodiments, the processor 304 may be integrated on the same die with other components to form a System on Chip (SoC).

In various embodiments, the flash memory 312 and/or storage device 311 may implement the memory system 100 described herein. The computing device 300 may include the storage device 311 in addition to, or instead of, the flash memory 312. In some embodiments, such as embodiments in which the storage device 311 implements an SSD, the storage device 311 may implement the memory system 100 described herein in addition to or instead of the flash memory 312.

In some embodiments, the one or more processor(s), flash memory 312, and/or storage device 311 may include associated firmware (not shown) storing programming instructions configured to enable computing device 300, in response to execution of the programming instructions by one or more processor(s) 304, to practice all or selected aspects of the methods described herein (e.g., method 200). In various embodiments, these aspects may additionally or alternatively be implemented using hardware separate from the one or more processor(s) 304, flash memory 312, or storage device 311.

The communication chips 306 may enable wired and/or wireless communications for the transfer of data to and from the computing device 300. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 306 may implement any of a number of wireless standards or protocols, including but not limited to IEEE 702.20, General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Bluetooth, derivatives thereof, as well as any other wireless protocols that are designated as 3G, 4G, 5G, and beyond. The computing device 300 may include a plurality of communication chips 306. For instance, a first communication chip 306 may be dedicated to shorter range wireless communications such as Wi-Fi and Bluetooth and a second communication chip 306 may be dedicated to longer range wireless communications such as GPS, EDGE, GPRS, CDMA, WiMAX, LTE, Ev-DO, and others.

In various implementations, the computing device 300 may be a laptop, a netbook, a notebook, an ultrabook, a smartphone, a computing tablet, a personal digital assistant (PDA), an ultra-mobile PC, a mobile phone, a desktop computer, a server, a printer, a scanner, a monitor, a set-top box, an entertainment control unit (e.g., a gaming console or automotive entertainment unit), a digital camera, an appliance, a portable music player, or a digital video recorder. In further implementations, the computing device 300 may be any other electronic device that processes data.

Some non-limiting Examples are provided below.

Example 1 is a method for managing a non-volatile memory comprising: reading a plurality of sectors of data from a non-volatile memory; allocating individual sectors to pages according to a completion time of the reading of individual sectors of the plurality of sectors, individual pages including a plurality of the sectors; and writing the individual pages that include the plurality of the sectors to the non-volatile memory.

Example 2 is the method of Example 1, further comprising updating an indirection table to indicate a location of the sectors in the non-volatile memory.

Example 3 is the method of Example 1, further comprising: storing the read sectors in a transfer buffer, wherein the pages of sectors are written to the non-volatile memory from the transfer buffer.

Example 4 is the method of Example 3, wherein the sectors of the individual pages are stored in contiguous slots of the transfer buffer according to their respective completion times.

Example 5 is the method of Example 3, wherein the sectors of the individual pages are stored in non-contiguous slots of the transfer buffer.

Example 6 is the method of Example 3, wherein the transfer buffer is a static random access memory (SRAM).

Example 7 is the method of any one of Examples 1 to 6, wherein the read sectors are allocated to pages sequentially according to their respective completion times.

Example 8 is the method of any one of Examples 1 to 6, wherein the reading, allocating, and writing are performed as part of a garbage collection process for the non-volatile memory.

Example 9 is the method of any one of Examples 1 to 6, wherein the non-volatile memory is a flash memory.

Example 10 is an apparatus for operating a memory comprising: a non-volatile memory; a transfer buffer; and controller logic coupled to the non-volatile memory and the transfer buffer. The controller logic is to: read a plurality of sectors of data from the non-volatile memory; store the read sectors in the transfer buffer; allocate individual sectors to pages according to a completion time of the read of individual sectors of the plurality of sectors, individual pages including a plurality of the sectors; and write the individual pages that include the plurality of the sectors to the non-volatile memory responsive to a determination that all sectors of the page have been read.

Example 11 is the apparatus of Example 10, further comprising an indirection table coupled to the controller logic that indicates a location of sectors in the non-volatile memory, wherein the garbage collection logic is further to update the indirection table to indicate the location of the sectors written to the non-volatile memory.

Example 12 is the apparatus of Example 10, wherein the sectors of the individual pages are stored in contiguous slots of the transfer buffer.

Example 13 is the apparatus of Example 10, wherein the sectors of the individual pages are stored in non-contiguous slots of the transfer buffer.

Example 14 is the apparatus of Example 10, wherein the read sectors are allocated to pages sequentially according to their respective completion times.

Example 15 is the apparatus of Example 10, wherein the transfer buffer is a static random access memory (SRAM).

Example 16 is the apparatus of Example 10, wherein the non-volatile memory is a flash memory.

Example 17 is the apparatus of any one of Examples 10 to 16, wherein the controller logic is to perform the read, store, allocate, and write operations as part of a garbage collection process for the non-volatile memory.

Example 18 is a system for operating a memory comprising: a processor; an antenna; a non-volatile memory coupled to the processor and the antenna; a transfer buffer; and controller logic coupled to the flash memory and the transfer buffer. The controller logic is to, as part of a garbage collection process: identify sectors of data, of a block of data including a plurality of sectors stored in the non-volatile memory, that are valid sectors to be kept; read the valid sectors from the non-volatile memory; store the read sectors in the transfer buffer; allocate the read sectors to pages according to a completion time of the read of individual sectors of the plurality of sectors, individual pages including a plurality of the sectors; and write the individual pages that include the plurality of the sectors to the non-volatile memory responsive to a determination that all sectors of the page have been read.

Example 19 is the system of Example 18, wherein the controller logic is further to erase the block of data after reading the valid sectors.

Example 20 is the system of Example 18, wherein the controller logic is further to erase the pages from the transfer buffer after writing the pages to the non-volatile memory.

Example 21 is the system of Example 18, further comprising an indirection table coupled to the controller logic that indicates a location of sectors in the non-volatile memory, wherein the controller logic is further to update the indirection table to indicate the location of the sectors written to the non-volatile memory.

Example 22 is the system of Example 18, wherein the sectors of the individual pages are stored in contiguous slots of the transfer buffer according to the completion time of the read of the individual sectors.

Example 23 is the system of Example 18, wherein the sectors of the individual pages are stored in non-contiguous slots of the transfer buffer.

Example 24 is the system of any one of Examples 18 to 23, wherein the read sectors are allocated to pages sequentially according to their respective completion times.

Although certain embodiments have been illustrated and described herein for purposes of description, this application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A method comprising:
reading a plurality of sectors of data from a non-volatile memory;
allocating individual sectors to pages according to a completion time of the reading of individual sectors of the plurality of sectors, individual pages including a plurality of the sectors; and
writing the individual pages that include the plurality of the sectors to the non-volatile memory.

2. The method of claim 1, further comprising updating an indirection table to indicate a location of the sectors in the non-volatile memory.

3. The method of claim 1, further comprising:
storing the read sectors in a transfer buffer, wherein the pages of sectors are written to the non-volatile memory from the transfer buffer.

4. The method of claim 3, wherein the sectors of the individual pages are stored in contiguous slots of the transfer buffer according to their respective completion times.

5. The method of claim 3, wherein the sectors of the individual pages are stored in non-contiguous slots of the transfer buffer.

6. The method of claim 3, wherein the transfer buffer is a static random access memory (SRAM).

7. The method of claim 1, wherein the read sectors are allocated to pages sequentially according to their respective completion times.

8. The method of claim 1, wherein the reading, allocating, and writing are performed as part of a garbage collection process for the non-volatile memory.

9. The method of claim 1, wherein the non-volatile memory is a flash memory.

10. An apparatus comprising:
a non-volatile memory;
a transfer buffer; and
controller logic coupled to the non-volatile memory and the transfer buffer, the controller logic to:
read a plurality of sectors of data from the non-volatile memory;
store the read sectors in the transfer buffer;
allocate individual sectors to pages according to a completion time of the read of individual sectors of the plurality of sectors, individual pages including a plurality of the sectors; and
write the individual pages that include the plurality of the sectors to the non-volatile memory responsive to a determination that all sectors of the page have been read.

11. The apparatus of claim 10, further comprising an indirection table coupled to the controller logic that indicates a location of sectors in the non-volatile memory, wherein the garbage collection logic is further to update the indirection table to indicate the location of the sectors written to the non-volatile memory.

12. The apparatus of claim 10, wherein the sectors of the individual pages are stored in contiguous slots of the transfer buffer.

13. The apparatus of claim 10, wherein the sectors of the individual pages are stored in non-contiguous slots of the transfer buffer.

14. The apparatus of claim 10, wherein the read sectors are allocated to pages sequentially according to their respective completion times.

15. The apparatus of claim 10, wherein the transfer buffer is a static random access memory (SRAM).

16. The apparatus of claim 10, wherein the non-volatile memory is a flash memory.

17. The apparatus of claim 10, wherein the controller logic is to perform the read, store, allocate, and write operations as part of a garbage collection process for the non-volatile memory.

18. A system comprising:
a processor;
an antenna;
a non-volatile memory coupled to the processor and to the antenna;
a transfer buffer; and
controller logic coupled to the flash memory and the transfer buffer, the controller logic to, as part of a garbage collection process:
identify sectors of data, of a block of data including a plurality of sectors stored in the non-volatile memory, that are valid sectors to be kept;
read the valid sectors from the non-volatile memory;
store the read sectors in the transfer buffer;
allocate the read sectors to pages according to a completion time of the read of individual sectors of the plurality of sectors, individual pages including a plurality of the sectors; and
write the individual pages that include the plurality of the sectors to the non-volatile memory responsive to a determination that all sectors of the page have been read.

19. The system of claim 18, wherein the controller logic is further to erase the block of data after reading the valid sectors.

20. The system of claim 18, wherein the controller logic is further to erase the pages from the transfer buffer after writing the pages to the non-volatile memory.

21. The system of claim 18, further comprising an indirection table coupled to the controller logic that indicates a location of sectors in the non-volatile memory, wherein the controller logic is further to update the indirection table to indicate the location of the sectors written to the non-volatile memory.

22. The system of claim 18, wherein the sectors of the individual pages are stored in contiguous slots of the transfer buffer according to the completion time of the read of the individual sectors.

23. The system of claim 18, wherein the sectors of the individual pages are stored in non-contiguous slots of the transfer buffer.

24. The system of claim 18, wherein the read sectors are allocated to pages sequentially according to their respective completion times.
